(19) United States
(12) Patent Application Publication
(10) Pub. No.: US 2010/0309986 A1
(43) Pub. Date: Dec. 9, 2010

(54) DATA PROCESSING DEVICE AS WELL AS A METHOD AND ELECTRONIC APPARATUS FOR DATA PLAYBACK PROCESSING

(75) Inventor: Eizo Fujisawa, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation

(21) Appl. No.: 12/865,714

(22) PCT Filed: Jan. 30, 2009
(86) PCT No.: PCT/JP2009/051650

§ 371 Date: Jul. 30, 2010

(30) Foreign Application Priority Data
Jan. 30, 2008 (JP) 2008-019945

(51) Int. Cl. H04N 11/02

(52) U.S. Cl. 375/240.25; 375/E07.027

(57) ABSTRACT

Provided are a data processing device as well as a method and mobile electronic apparatus for data playback processing with which playback processing can be performed without causing television viewers discomfort. The invention is equipped with a time information table-generating component 204 which generates time information tables by extracting prescribed time information from encoded data, a decision component 205 which decides whether or not the time information is extracted at regular time intervals by referring to the time information tables, a data omission time-calculating component 206 which calculates data omission times, and a control component 207 which, if the decision component 205 decides that the omission time is longer than a prescribed time period, carries out control in such a way that playback processing is performed by inserting arbitrarily defined data while deleting data at a location corresponding to the relevant omission time period, and if said decision component 205 decides that the omission time is shorter than a prescribed time period, the control component 207 carries out control in such a way that said playback processing is performed by inserting arbitrarily defined data without deleting data at a location corresponding to the relevant omission time period.

### TECHNICAL FIELD

The present invention relates to a data processing device, a data reproduction processing method and an electronic device, in which decoding processing is performed on encoded data, and reproduction processing is performed on data after the decoding processing.

### BACKGROUND ART

In recent years, some portable electronic devices include, for example: an antenna unit that receives television broadcast waves; a demodulation processing unit that performs demodulation processing on the television broadcast waves received via the antenna unit; a separation processing unit that separates the signal (transport stream (TS)), on which the demodulation processing has been performed, into a sound TS and an image TS; a sound TS decoding processing unit that performs decoding processing on the sound TS on which the separation processing has been performed; an image TS decoding processing unit that performs decoding processing on the image TS on which the separation processing has been performed; a speaker that outputs sound on which the decoding processing has been performed by the sound TS decoding processing unit; a display that outputs an image on which the decoding processing has been performed by the image TS decoding processing unit; and a synchronization processing unit that extracts a synchronizing signal from the TS, and performs synchronous processing of sound and an image.

Moreover, such a portable electronic device also has a function to record received contents into memory.

Here, in a case in which a stream has been lost when recording the contents, there is a method (hereinafter referred to as a first reproduction method) of performing reproduction without changing the actual time by displaying a previous screen or inserting a black image into a lost portion, and as proposed in Patent Document 1, there is a method (hereinafter referred to as a second reproduction method) of performing reproduction by reducing the actual time by omitting the lost portion.

Patent Document 1: Japanese Unexamined Patent Application Publication No. 2006-238003

### DISCLOSURE OF THE INVENTION

### Problems to be Solved by the Invention

However, in a portable electronic device that employs the first reproduction method, for example, in a case in which a stream over a long period of time spanning several minutes has been lost, a previous screen or a black screen will be reproduced in a silence state for several minutes, and thus the viewers feel discomfort from the image. Therefore, this reproduction method is not a preferable reproduction mode.

In addition, in a portable electronic device that employs the second reproduction method, for example, in a case in which a stream over a short period of time spanning several seconds has been lost, the image and sound for the several seconds will be reduced, and thus the viewers feel discomfort. Therefore, this reproduction method is not a preferable reproduction mode either.

The present invention has been made in view of the problems as described above. An object thereof is to provide a data processing device, a data reproduction processing method and an electronic device that are capable of performing reproduction processing without giving discomfort to viewers.

### Means for Solving the Problems

In order to solve the abovementioned problems, a data processing device according to the present invention includes: a decoding processing unit that performs decoding processing on data encoded in accordance with a predetermined standard; a data reproduction processing unit that performs reproduction processing on data after the decoding processing; a data loss time calculating unit that calculates a data loss time; and a control unit that performs, in a case in which loss occurs in the data on which reproduction processing is to be performed, any one of first processing that performs reproduction by reducing a reproduction time of the data in terms of the loss, or second processing that inserts arbitrary data into a portion of the loss in the data, based on a loss time calculated by the data loss time calculating unit, and switches the processing to be performed based on the loss time calculated by the data loss time calculating unit.

Moreover, in the data processing device, it is preferable that the control unit determines whether the loss time calculated by the data loss time calculating unit is longer than a predetermined time, performs the first processing in a case of the loss time having been determined to be longer than the predetermined time, and performs the second processing in a case of the loss time having been determined to be shorter than the predetermined time.

In addition, in the data processing device, it is preferable that the control unit omits data of a portion corresponding to the loss time from a time for which reproduction processing is to be performed, in a case of performing the first processing.

Furthermore, in the data processing device, it is preferable that the control unit inserts arbitrary data without omitting data of a portion corresponding to the loss time, in a case of performing the second processing.

Moreover, in the data processing device, it is preferable that the data loss time calculating unit calculates a data loss time, based on a packet that contains sequence information included in the data.

In addition, in the data processing device, it is preferable that the packet that contains sequence information is a packet that contains predetermined time information at a certain time interval included in the data encoded, and the data processing device further includes: a time information table generating unit that extracts the packet that includes time information, and generates a time information table; and a determination unit that refers to the time information table, and determines whether the time information is extracted at the certain time interval, and in which the data loss time calculating unit estimates that loss is occurring in the data encoded, and calculates a data loss time based on time information immediately preceding, and time information immediately following, a portion that is not in the certain time interval, in a case of having determined that the time information is not extracted at the certain time interval.

Furthermore, in the data processing device, it is preferable that the control unit inserts arbitrary data into the loss time, and performs the reproduction processing, in a case of having determined that the loss time is longer than a predetermined time.

Moreover, in the data processing device, it is preferable that the data loss time calculating unit analyzes a packet to which the time information immediately preceding belongs, and obtains first reproduction start time information that defines timing for starting reproduction and a reproduction time, analyzes a packet to which the time information immediately following belongs, and obtains second reproduction start time information that defines timing for starting reproduction, and calculates a loss time of the data, based on the first reproduction start time, the reproduction time, and the second reproduction start time information.

In addition, in the data processing device, it is preferable that the arbitrary data is data of a black image or data of an image immediately preceding.

Furthermore, in the data processing device, it is preferable that the control unit performs control so as to visually or auditorily notify that data has been lost and the arbitrary data has been inserted.

Moreover, it is preferable that the data processing device further includes a receiving unit, and the data loss time calculating unit calculates a loss time of data that has been received by the receiving unit.

In order to solve the aforementioned problems, a data reproduction processing method according to the present invention is a data reproduction processing method, in which decoding processing is performed on data encoded in accordance with a predetermined standard, and reproduction processing is performed on data after the decoding processing, in which the method includes: a data loss time calculating step of calculating a loss time of data that has been received; and a processing step of performing, in a case in which loss occurs in the data on which reproduction processing is to be performed, any one of first processing that performs reproduction by reducing a reproduction time of the data in terms of the loss, or second processing that inserts arbitrary data into a portion of the loss in the data, based on a loss time calculated in the data loss time calculating step, and switching the processing to be performed, based on the loss time calculated in the data loss time calculating step.

In addition, in order to solve the aforementioned problems, in the data reproduction processing method, it is preferable that, in the processing step, it is determined whether the loss time calculated in the data loss time calculating step is longer than a predetermined time, any one of the first processing or the second processing is performed, and the processing to be performed is switched based on the loss time calculated in the data loss time calculating step.

In order to solve the abovementioned problems, an electronic device according to the present invention includes: a decoding processing unit that performs decoding processing on data encoded in accordance with a predetermined standard; a data reproduction processing unit that performs reproduction processing on data after the decoding processing; a data loss time calculating unit that calculates a data loss time; and a control unit that performs, in a case in which loss occurs in the data on which reproduction processing is to be performed, any one of first processing that performs reproduction by reducing a reproduction time of the data in terms of the loss or second processing that inserts arbitrary data into a portion of the loss in the data, based on a loss time calculated by the data loss time calculating unit, and switches the processing to be performed based on the loss time calculated by the data loss time calculating unit.

Furthermore, in the electronic device, it is preferable that the control unit determines whether the loss time calculated by the data loss time calculating unit is longer than a predetermined time, performs any one of the first processing or the second processing, and switches the processing to be performed based on the loss time calculated by the data loss time calculating unit.

### EFFECTS OF THE INVENTION

The present invention can provide reproduction processing that does not give discomfort to viewers.

### BRIEF DESCRIPTION OF THE DRAWINGS

FIG. 1 is a front view of a state in which a cellular telephone device is opened (a first opened state);

FIG. 2 (A) is a left side view of a state in which the cellular telephone device is opened, and FIG. 2 (B) is a right side view of a state in which the cellular telephone device is opened;

FIG. 3 is a block diagram in which functions of the cellular telephone device according to the present invention are shown;

FIG. 4 is a block diagram in which functions of a broadcast wave processing unit provided to the cellular telephone device according to the present invention are shown;

FIG. 5 is a diagram in which a configuration of a TS packet is shown;

FIG. 6 is a diagram illustrating PCRs;

FIG. 7 is a diagram illustrating a method of calculating a data loss time; and

FIG. 8 is a diagram in which reproduction images after control has been performed in accordance with the data loss time are shown.

### EXPLANATION OF REFERENCE NUMERALS

1 cellular telephone device
22 antenna unit
151 memory
200 broadcast wave processing unit
201 reception processing unit
202 decoding processing unit
203 reproduction processing unit
204 time information table generating unit
205 determination unit
206 data loss time calculating unit
207 control unit
208 write/read unit

### PREFERRED MODE FOR CARRYING OUT THE INVENTION

An embodiment of the present invention is hereinafter described with reference to the drawings. A cellular telephone device is hereinafter described as an electronic device including a data processing device according to the present invention. However, the present invention is not limited thereto, and may be a PHS (Personal Handyphone System), a PDA (Personal Digital Assistant), a portable navigation device, a notebook PC or the like.

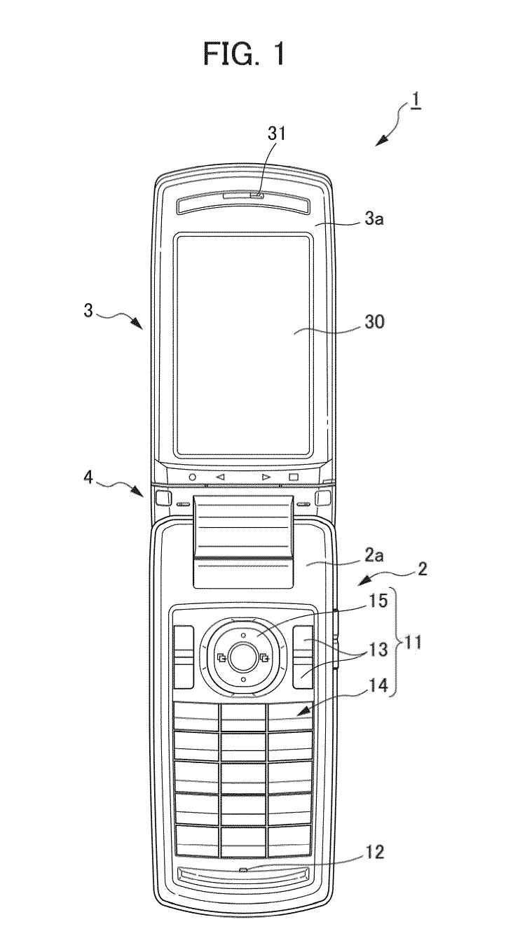

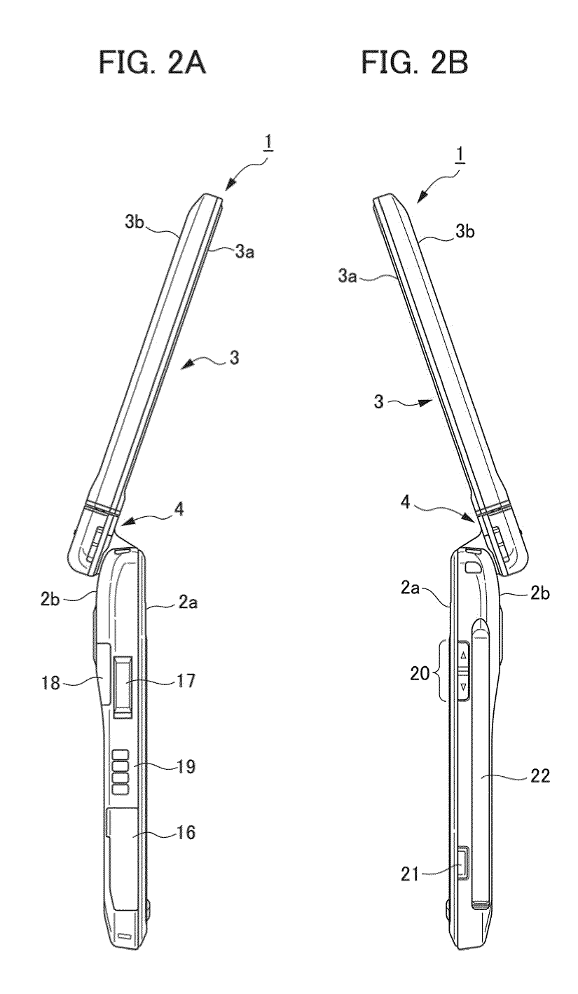

FIG. 1 is a front view of a state in which a cellular telephone device 1 is opened (a first opened state). Moreover, FIG. 2 (A) is a left side view of a state in which the cellular telephone device 1 is opened, and FIG. 2 (B) is a right side view of a state in which the cellular telephone device 1 is opened.

The cellular telephone device 1 includes an operation unit side body 2 and a display unit side body 3. The operation unit side body 2 and the display unit side body 3 are connected via a connecting portion 4 including a hinge mechanism. The cellular telephone device 1 is configured so as to be able to be transformed into an opened state and a closed state.

The closed state is a state in which both bodies are disposed so as to be mutually superimposed. The opened state is a state in which both bodies are disposed so as not to be mutually superimposed. A front side state in the opened state is a state in which a display 30 disposed on a surface 3A in the display unit side body 3 to be described later and an operation key set 11 disposed in a front case 2a in the operation unit side body 2 are disposed so as to face the same side. In addition, a back side state is a state in which the display 30 in the display unit side body 3 and the operation key set 11 in the operation unit side body 2 are disposed so as to face opposite sides.

An outer surface of the operation unit side body 2 is configured with a front case 2a and a rear case 2b. The operation unit side body 2 has the operation key set 11 and a sound input unit 12 (microphone) so as to be exposed on the front case 2a side, in which sounds that a user of the cellular telephone device 1 produces during a phone call are input. The operation key set 11 has: feature setting operation keys 13 for a user to operate various settings and various features such as a telephone number directory feature and a mail feature; input operation keys 14 for the user to input digits of a telephone number and characters for mail, and a selection operation key 15 for the user to perform selection of the various operations and scrolling up, down, left and right. Furthermore, the microphone 12 is disposed to an outer end side that is opposite to the connecting portion 4 side in a longitudinal direction of the operation unit side body 2. In other words, the microphone 12 is disposed to one outer end side of the cellular telephone device 1 in the opened state.

Each key configuring the operation key set 11 has predetermined functions (key assignment) in accordance with a transformation state such as the opened/closed state and the front/back side state of the operation unit side body 2 and the display unit side body 3, and the type of application that is running. By the user depressing one of the keys configuring the operation key set 11, the cellular telephone device 1 executes an operation corresponding to a function assigned to each key.

As shown in FIG. 2(A), one side of the operation unit side body 2 has: an interface 16 for transmitting and receiving data to and from an external device (for example, a host device), a headphone/microphone terminal 17, a detachable external memory interface 18, and a charging terminal 19 for recharging a battery. It should be noted that the interface 16, the headphone/microphone terminal 17 and the interface 18 are covered with a detachable cap to protect from dust when not in use.

As shown in FIG. 2(B), another side of the operation unit side body 2 has: a pair of side keys 20, an operation key 21 used when capturing an image, and an antenna unit 22 for receiving broadcast waves, in which a reception angle of waves can be adjusted. Predetermined functions are assigned to the side keys 20 (key assignment) in accordance with the opened/closed state of the operation unit side body 2 and the display unit side body 3, and the type of application that is running. When the side keys 20 are depressed by the user, the cellular telephone device 1 executes an operation corresponding to a function assigned to the side keys 20.

Moreover, an outer surface of the display unit side body 3 is configured with a front case 3a and a rear case 3b. As shown in FIG. 1, the front case 3a in the display unit side body 3 has: the display 30 of a predetermined shape for displaying a variety of information, and a sound output unit 31 that outputs sound of the other party of the conversation, so as to be exposed on an outer surface thereof. The sound output unit 31 is disposed to an outer end side that is opposite to the connecting portion 4 in a longitudinal direction of the display unit side body 3. In other words, the sound output unit 31 is disposed to another outer end side of the cellular telephone device 1 in the opened state.

It should be noted that the cellular telephone device 1 is described as being foldable via the connecting portion 4 in the present embodiment. However, instead of such a flip type, the present embodiment can be carried out with the cellular telephone device 1 of: a slider type in which one body slides to one direction from a state in which the operation unit side body 2 and the display unit side body 3 are mutually superimposed; a rotating type (turning type) in which one body is rotated around an axis line along the direction of superimposing the operation unit side body 2 and the display unit side body 3; and a type (straight type) in which the operation unit side body 2 and the display unit side body 3 are disposed in a single body without a connecting portion.

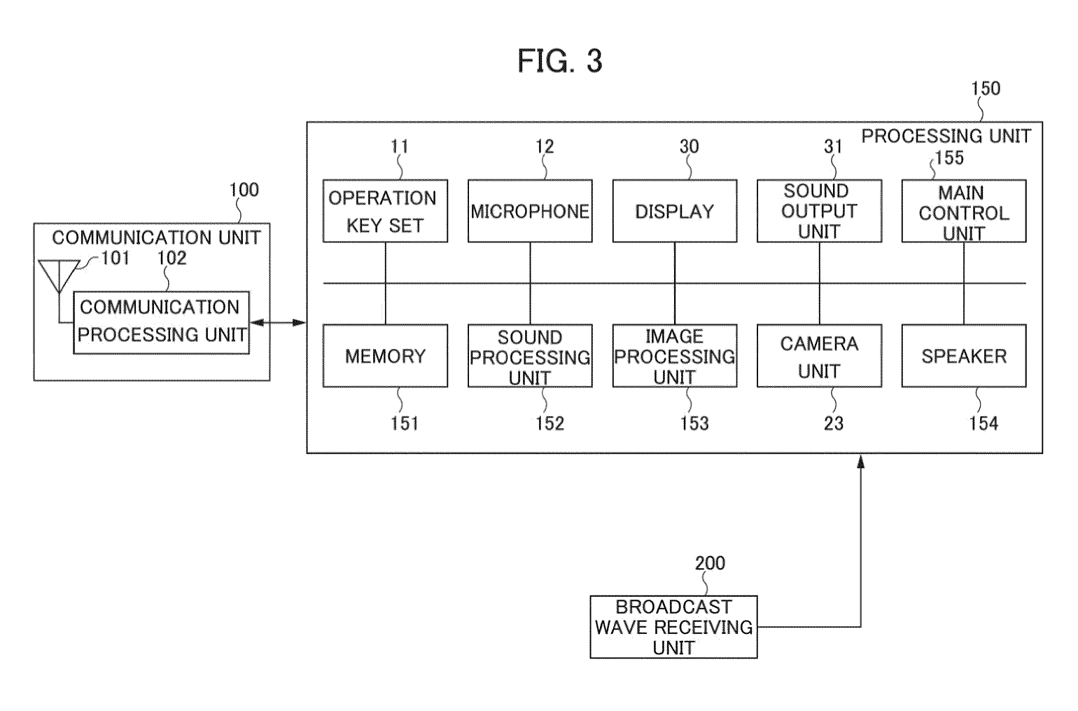

FIG. 3 is a functional block diagram illustrating each function of the cellular telephone device 1. As shown in FIG. 3, the cellular telephone device 1 includes: a communication unit 100 that communicates with an external device (such as a radio base station); a processing unit 150 that performs predetermined processing; and a broadcast wave receiving unit 200 that receives broadcast waves.

The communication unit 100 includes an antenna unit 101 and a communication processing unit 102. The antenna unit 101 performs communication by phone and communication by mail with other communication terminals via a base station, based on a predetermined communication method (for example, CDMA (Code Division Multiple Access) 2000_{—}1× or the like). The communication processing unit 102 is configured with: a transmitting circuit that performs transmission processing; and a receiving circuit that performs reception processing.

For example, the antenna unit 101 communicates with a base station via a predetermined usable frequency band (for example, 800 MHz). It should be noted that the usable frequency band may be a usable frequency band other than 800 MHz. Moreover, the antenna unit 101 may be configured to be compatible with a plurality of usable frequency bands.

The communication processing unit 102 performs demodulation processing by way of the receiving circuit on a signal received via the antenna unit 101. The communication processing unit 102 then transmits the processed signal, on which the demodulation processing has been performed, to the processing unit 150. In addition, the communication processing unit 102 performs modulation processing by the transmitting circuit on a signal transmitted from the processing unit 150. The communication processing unit 102 then transmits the processed signal, on which the modulation processing has been performed, to an external device via the antenna unit 101.

Furthermore, the processing unit 150 includes: the operation key set 11; the microphone 12; the display 30; the sound output unit 31; memory 151 that stores predetermined data; a sound processing unit 152 that performs predetermined sound processing; an image processing unit 153 that performs predetermined image processing; a camera unit 23 that captures an image of a subject; a speaker 154 that outputs ringtones and the like; a main control unit 155 that controls each component, etc. It should be noted that the memory 151 is detachable memory. Moreover, the memory 151 stores contents received via the broadcast wave receiving unit 200, etc.

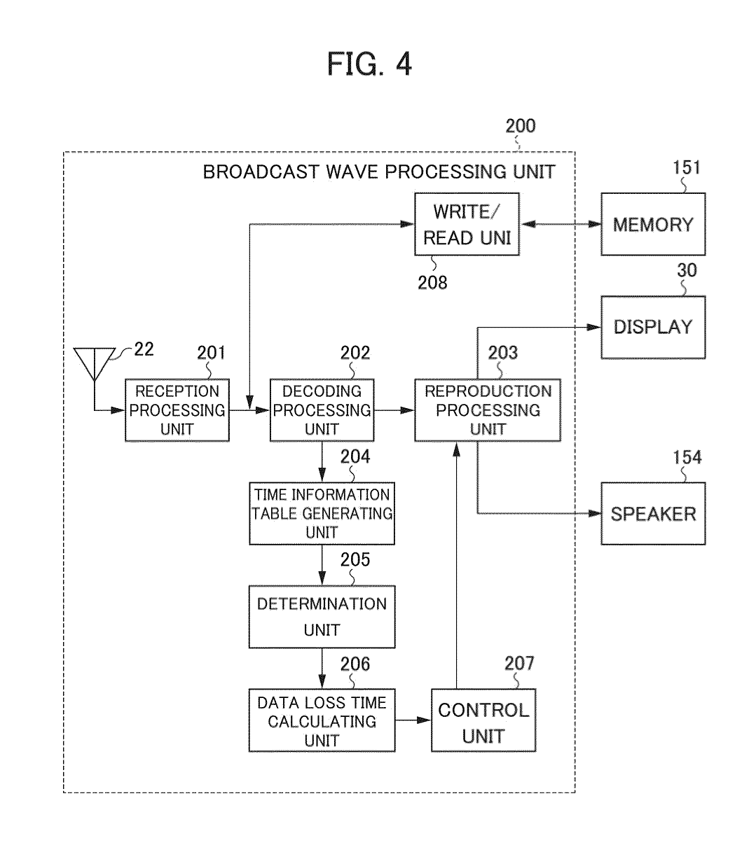

FIG. 4 is a diagram illustrating the broadcast wave receiving unit 200 and devices connected to the broadcast wave receiving unit 200. The broadcast wave receiving unit 200 includes the antenna unit 22, a reception processing unit 201, a decoding processing unit 202, a reproduction processing unit 203, a time information table generating unit 204, a determination unit 205, a data loss time calculating unit 206, and a control unit 207. The reception processing unit 201 is connected to the antenna unit 22. The decoding processing unit 202 receives a signal processed by the reception processing unit 201. The reproduction processing unit 203 receives a signal on which decoding processing has been performed by the decoding processing unit 202. The time information table generating unit 204 receives a signal processed by the reception processing unit 201. The determination unit 205 is connected to the time information table generating unit 204. The data loss time calculating unit 206 is connected to the determination unit 205. The control unit 207 is connected to the data loss time calculating unit 206, and performs predetermined control. In addition, the broadcast wave receiving unit 200 includes a write/read unit 208 that writes and reads a signal (stream) that has been processed by the reception processing unit 201, into and from the memory 151.

The antenna unit 22 receives a signal propagating via space, and transmits the received signal to the reception processing unit 201. Furthermore, in the antenna unit 22, a reception angle of radio waves can be adjusted as described above. It should be noted that it is assumed that a signal received via the antenna unit 22 is encoded based on a predetermined standard (for example, MPEG (moving picture experts group) 2).

The reception processing unit 201 performs predetermined processing. More specifically, the reception processing unit 201 receives a digital broadcast signal, on which modulation/compression processing has been performed according to a predetermined method, and performs reconstruction processing on a TS (Transport Stream) packet transmitted from a broadcasting station, based on the digital broadcast signal thus received.

The TS packet has an image TS packet, a sound TS packet, and additional information such as subtitles or program information. Moreover, this additional information has time information that defines timing of starting decoding processing (DTS: decoding time stamp), time information that defines timing of performing reproduction (PTS: Presentation Time Stamp), etc.

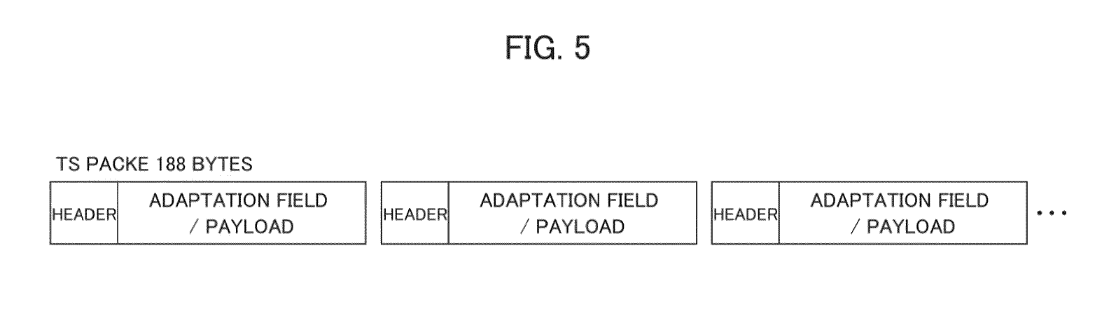

In addition, the TS packet is a packet with a fixed length of 188 bytes. Furthermore, as shown in FIG. 5, the TS packet is configured with a header with 4 fixed bytes, an adaptation field with a variable length of 184 bytes, and a payload. Moreover, a PID (Packet Identifier) is described in a header. A packet is identified by way of this PID.

In addition, a PES (Packetized Elementary Stream) packet is configured by connecting payload portions of a plurality of TS packets of the same PID.

Furthermore, the PES packet has a PCR (Program Clock Reference) at a certain time interval for each packet. Herein, the PCR is reference time information that is referred to when decoding processing is performed on encoded data by the decoding processing unit 202, and when reproduction processing is performed on decoded data by the reproduction processing unit 203. Therefore, the broadcast wave receiving unit 200 can obtain time information of the system by referring to the PCR.

Moreover, in the PES packet, a single piece of media information is packetized in a certain presentation unit. In addition, the PES packet serves as a unit that performs time management of media reproduction. Therefore, a single PES packet configures a single frame.

The decoding processing unit 202 performs decoding processing, for each packet, on data related to a signal on which reconstruction processing has been performed by the reception processing unit 201, or on data read from the memory 151 by the write/read unit 208.

The reproduction processing unit 203 performs reproduction processing on data after the decoding processing by the decoding processing unit 202. The reproduction processing unit 203 then transmits an image signal after the reproduction processing to the display 30, and transmits a sound signal after the reproduction processing to the speaker 154.

The time information table generating unit 204 generates a time information table by extracting predetermined time information that is included in encoded data for each packet at a certain time interval. It should be noted that the predetermined time information is, for example, a PCR defined in MPEG 2.

By referring to the time information table, the determination unit 205 determines whether time information is extracted at a certain time interval.

In a case in which the determination unit 205 has determined that time information is not extracted at a certain time interval, the data loss time calculating unit 206 estimates that loss of encoded data is occurring. The data loss time calculating unit 206 then calculates a data loss time, based on time information immediately preceding and time information immediately following a portion that is not in the certain time interval.

Furthermore, the data loss time calculating unit 206 may have a configuration that analyzes a packet to which the time information immediately preceding belongs, obtains first reproduction start time information that defines the timing for starting reproduction and a reproduction time, analyzes a packet to which the time information immediately following belongs, obtains second reproduction start time information that defines the timing for starting reproduction, and calculates a data loss time, based on the first reproduction start time information, the reproduction time, and the second reproduction start time information.

The control unit 207 determines whether the loss time calculated by the data loss time calculating unit 206 is longer than a predetermined time, and in a case in which it has been determined that the loss time is longer than the predetermined time, performs control such that reproduction processing is performed by the reproduction processing unit 203 by way of omitting data of a portion corresponding to the loss time (first processing), and in a case in which it has been determined that the loss time is shorter than a predetermined time, performs control such that reproduction processing is performed by the reproduction processing unit 203 by way of inserting arbitrary data without omitting data of a portion corresponding to the loss time (second processing). It should be noted that the reproduction processing unit 203 may be configured to control so as to perform reproduction processing by way of inserting arbitrary data in the first processing.

Moreover, the arbitrary data is, for example, data of a black image or data of an image immediately preceding. In addition, for example, when a black image or an image immediately preceding is inserted, the control unit 207 may insert the black image or the image immediately preceding such that the screen gradually becomes brighter to display the image (fade-in insertion). Furthermore, for example, when the data of the black image or the image immediately preceding is eliminated, the control unit 207 may eliminate the black image or the image immediately preceding such that the image gradually disappears (fade-out). Moreover, when the black image or the image immediately preceding is inserted, the control unit 207 may additionally insert a message indicating how many seconds the image has been lost.

### Embodiment

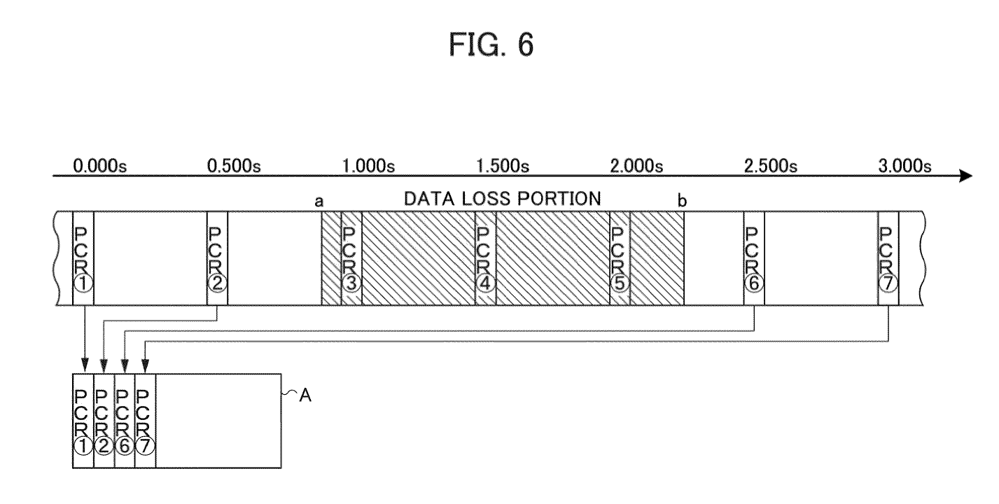

Here, specific behavior of the broadcast wave receiving unit 200 is described. It should be noted that, in the following, it is assumed that data (stream) has been lost during a certain period of time (a period a-b in FIG. 6) in an image PES.

Moreover, the PCRs retain time information of the system as described above. In addition, as shown in FIG. 6, since the PCRs are placed at a predetermined time interval (for example, an interval of 0.5 seconds), the broadcast wave receiving unit 200 can predict data loss by monitoring the PCRs.

The time information table generating unit 204 extracts only PCRs from each image PES, and generates a time information table A (see FIG. 6). The determination unit 205 monitors the time information table A generated by the time information table generating unit 204, and determines whether PCRs are extracted at a predetermined time interval. In the example shown in FIG. 6, the time information table generating unit 204 cannot extract PCRs 3 to 5.

The determination unit 205 refers to the time information table A, recognizes that the PCRs 3 to 5 have not been able to be extracted, and determines that the data has been lost.

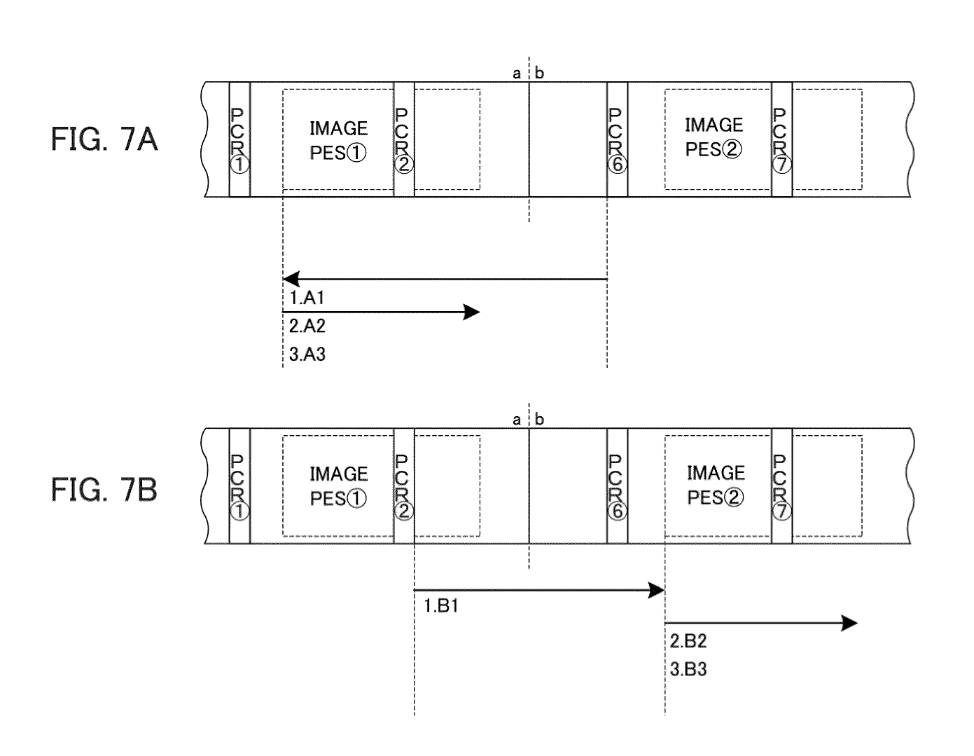

The data loss time calculating unit 206 calculates an accurate loss time between the PCRs 2 to 6, based on a result of determination by the determination unit 205. The data loss time calculating unit 206 starts searching the head of the image PES from the position of PCR 6 in the direction of the past data (“A1” in FIG. 7 (A)). The data loss time calculating unit 206 determines whether data is lost in the image PES 1 that has been searched at first (“A2” in FIG. 7 (A)).

In a case in which the data loss time calculating unit 206 has determined that data is not lost in the image PES 1, the data loss time calculating unit 206 analyzes a header of the image PES 1, and obtains a PTS 1 and a reproduction start time (DRU 1) (“A3” in FIG. 7 (A)). It should be noted that, since packets of a plurality of contents are multiplexed in PES in general, the image PES in the same content rarely continues, but it is assumed for convenience that the image PES continues in the same content in the present embodiment.

Next, the data loss time calculating unit 206 starts searching the head of the image PES from the position of PCR 2 in the direction of the future data (“B1” in FIG. 7 (B)). The data loss time calculating unit 206 determines whether data is lost in the image PES 2 that has been searched at first (“B2” in FIG. 7 (B)).

In a case in which the data loss time calculating unit 206 has determined that data is not lost in the image PES 2, the data loss time calculating unit 206 analyzes a header of the image PES 2, and obtains a PTS 2 (“B3” in FIG. 7 (B)).

The data loss time calculating unit 206 performs predetermined calculation (PTS 2−(PTS 1+DRU 1)) to calculate a data loss time.

The control unit 207 determines whether the data loss time is longer or shorter than a predetermined time, based on a result of calculation by the data loss time calculating unit 206.

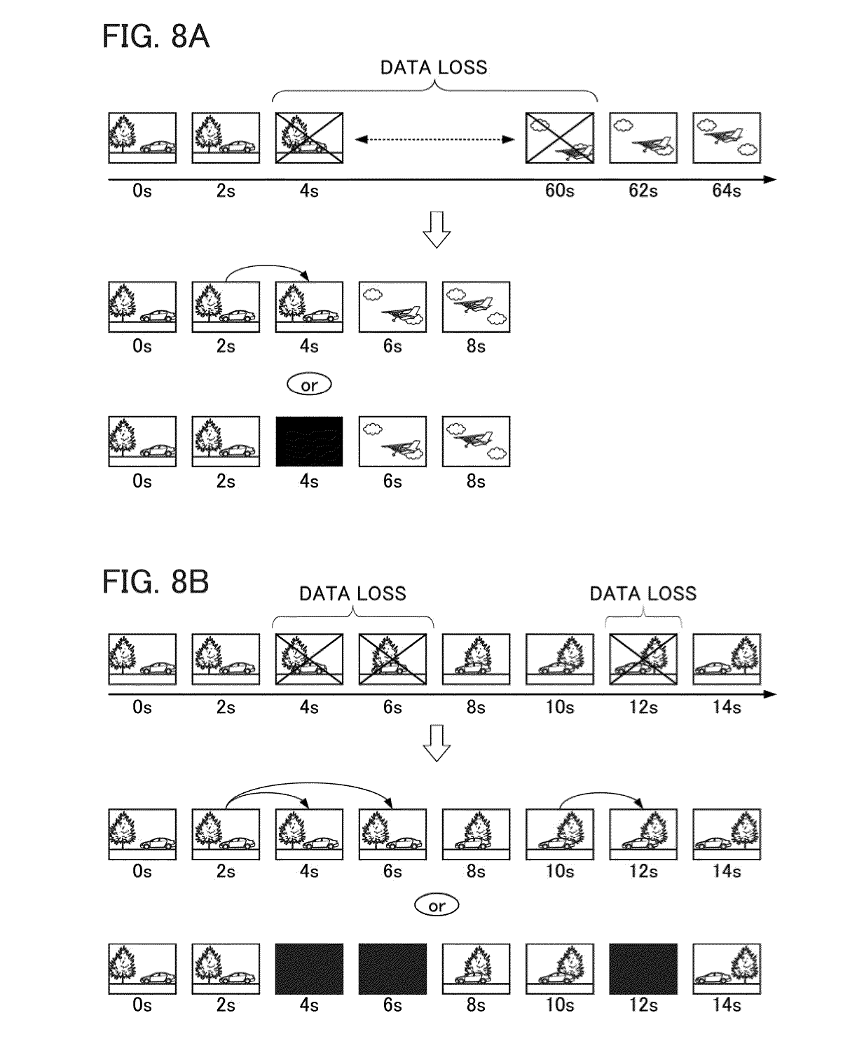

In a case in which the control unit 207 has determined that the loss time is longer than a predetermined time (for example, 3 seconds), the control unit 207 performs control such that reproduction processing is performed by the reproduction processing unit 203 by omitting data of a portion corresponding to the loss time. Therefore, for example, in a case in which the loss time is the 56 seconds between 4 s to 60 s, since the loss time is longer than the predetermined time, the control unit 207 performs control such that the reproduction processing unit 203 outputs, to the display 30, a reproduction image, of which the reproduction time is shortened, and into which an arbitrary image such as a black image is inserted, as shown in FIG. 8 (A). Therefore, according to the present invention, in a case in which data over a long period of time has been lost, reproduction of a previous screen, a black image, etc. for a long period of time can be suppressed, thereby making it possible to provide satisfactory reproduction without giving discomfort to viewers.

Moreover, in a case in which the control unit 207 has determined that the loss time is shorter than a predetermined time (for example, 3 seconds), the control unit 207 performs control such that reproduction processing is performed by the reproduction processing unit 203 without omitting the data of a portion corresponding to the loss time. Therefore, for example, in a case in which the loss time is the 2 seconds between 4 s to 6 s, since the loss time is shorter than the predetermined time, the control unit 207 performs control such that the reproduction processing unit 203 outputs, to the display 30, a reproduction image, in which data of a portion corresponding to the loss time is not omitted, and into which an arbitrary image such as a black image is inserted, and display is performed, as shown in FIG. 8 (B). Therefore, according to the present invention, in a case in which data over a short period of time such as several seconds has been lost, reduction of an image and sound in such several seconds can be suppressed, thereby making it possible to provide satisfactory reproduction without giving discomfort to viewers. It should be noted that FIG. 8 (B) shows reproduction control in a case in which data over a short period of time has been lost at two portions (from 4 s to 6 s, and at 12 s).

In this way, since the cellular telephone device 1 according to the present invention appropriately changes a display method depending on the data loss time, it is possible to provide a reproduction mode that facilitates viewing by viewers.

It should be noted that, in a case in which the loss time is equivalent to a predetermined time, the control unit 207 may perform control such that data of a portion corresponding to the loss time is omitted, or may perform control such that the data of the portion corresponding to the loss time is not omitted.

In addition, although a case was exemplified in the foregoing in which a stream for a certain period had been lost in the image PES, the embodiments are not limited thereto. For example, the present invention can also be applied to a case in which a sound PES stream over a certain period has been lost.

Furthermore, although it is assumed in the present embodiment that the decoding processing unit 202, the reproduction processing unit 203, the time information table generating unit 204, the determination unit 205, the data loss time calculating unit 206 and the control unit 207 are provided to the broadcast wave receiving unit 200, the embodiments are not limited thereto. For example, the decoding processing unit 202, the reproduction processing unit 203, the time information table generating unit 204, the determination unit 205, the data loss time calculating unit 206 and the control unit 207 may be provided to the processing unit 150. Moreover, in the present embodiment, although the determination unit 205, the data loss time calculating unit 206 and the control unit 207 each independently perform each processing, the embodiments are not limited thereto. For example, the determination unit 205, the data loss time calculating unit 206 and the control unit 207 may be integrally configured with the main control unit 155.

In addition, in the present embodiment, although the determination unit 205 was described as performing determination of data loss based on the regularity of the PCRs in MPEG 2-TS, the embodiments are not limited thereto. For example, the determination unit 205 may perform determination of data loss based on regularity of TOT or PTS of an image or sound.

Furthermore, in the present embodiment, although the type of data, for which a loss time is calculated, is an image or sound received via the antenna unit 101, the embodiments are not limited thereto. For example, it may be applied to an image or sound stored in the cellular telephone device 1.

1. A data processing device, comprising:
a decoding processing unit that performs decoding processing on data encoded in accordance with a predetermined standard;
a data reproduction processing unit that performs reproduction processing on data after the decoding processing;
a data loss time calculating unit that calculates a data loss time; and
a control unit that performs, in a case in which loss occurs in the data on which reproduction processing is to be performed, any one of first processing that performs reproduction by reducing a reproduction time of the data in terms of the loss, or second processing that inserts arbitrary data into a portion of the loss in the data, based on a loss time calculated by the data loss time calculating unit, and switches the processing to be performed based on the loss time calculated by the data loss time calculating unit.

2. The data processing device according to claim 1,
wherein the control unit determines whether the loss time calculated by the data loss time calculating unit is longer than a predetermined time,
performs the first processing in a case of the loss time having been determined to be longer than the predetermined time, and
performs the second processing in a case of the loss time having been determined to be shorter than the predetermined time.

3. The data processing device according to claim 2,
wherein the control unit omits data of a portion corresponding to the loss time from a time for which reproduction processing is to be performed, in a case of performing the first processing.

4. The data processing device according to claim 2,
wherein the control unit inserts arbitrary data without omitting data of a portion corresponding to the loss time, in a case of performing the second processing.

5. The data processing device according to claim 1,
wherein the data loss time calculating unit calculates a data loss time, based on a packet that contains sequence information included in the data.

6. The data processing device according to claim 5,
wherein the packet that contains sequence information is a packet that contains predetermined time information at a certain time interval included in the data encoded,
wherein the data processing device further comprises:
a time information table generating unit that extracts a packet that contains the time information, and generates a time information table; and
a determination unit that refers to the time information table, and determines whether the time information is extracted at the certain time interval, and
wherein the data loss time calculating unit estimates that loss is occurring in the data encoded, and calculates a data loss time based on time information immediately preceding, and time information immediately following, a portion that is not in the certain time interval, in a case of having determined that the time information is not extracted at the certain time interval.

7. The data processing device according to claim 1,
wherein the control unit inserts arbitrary data into the loss time, and performs the reproduction processing, in a case of having determined that the loss time is longer than a predetermined time.

8. The data processing device according to claim 6,
wherein the data loss time calculating unit analyzes a packet to which the time information immediately preceding belongs, and obtains first reproduction start time information that defines timing for starting reproduction and a reproduction time,
analyzes a packet to which the time information immediately following belongs, and obtains second reproduction start time information that defines timing for starting reproduction, and
calculates a loss time of the data, based on the first reproduction start time, the reproduction time, and the second reproduction start time information.

9. The data processing device according to claim 1,
wherein the arbitrary data is data of a black image or data of an image immediately preceding.

10. The data processing device according to claim 1,
wherein the control unit performs control so as to visually or auditorily notify that data has been lost and the arbitrary data has been inserted.

11. The data processing device according to claim 1,
further comprising a receiving unit,
wherein the data loss time calculating unit calculates a loss time of data that has been received by the receiving unit.

12. A data reproduction processing method in which decoding processing is performed on data encoded in accordance with a predetermined standard, and reproduction processing is performed on data after the decoding processing, the method comprising:
a data loss time calculating step of calculating a loss time of data that has been received; and
a processing step of performing, in a case in which loss occurs in the data on which reproduction processing is to be performed, any one of first processing that performs reproduction by reducing a reproduction time of the data in terms of the loss, or second processing that inserts arbitrary data into a portion of the loss in the data, based on a loss time calculated in the data loss time calculating step, and switching the processing to be performed, based on the loss time calculated in the data loss time calculating step.

13. The data reproduction processing method according to claim 12,
wherein, in the processing step, it is determined whether the loss time calculated in the data loss time calculating step is longer than a predetermined time, any one of the first processing or the second processing is performed, and the processing to be performed is switched based on the loss time calculated in the data loss time calculating step.

14. An electronic device, comprising:
a decoding processing unit that performs decoding processing on data encoded in accordance with a predetermined standard;
a data reproduction processing unit that performs reproduction processing on data after the decoding processing;
a data loss time calculating unit that calculates a data loss time; and
a control unit that performs, in a case in which loss occurs in the data on which reproduction processing is to be performed, any one of first processing that performs reproduction by reducing a reproduction time of the data in terms of the loss or second processing that inserts arbitrary data into a portion of the loss in the data, based on a loss time calculated by the data loss time calculating unit, and switches the processing to be performed based on the loss time calculated by the data loss time calculating unit.

15. The electronic device according to claim 14,
wherein the control unit determines whether the loss time calculated by the data loss time calculating unit is longer than a predetermined time, performs any one of the first processing or the second processing, and switches the processing to be performed based on the loss time calculated by the data loss time calculating unit.
